(19) United States
(12) Patent Application Publication
(10) Pub. No.: US 2004/0030593 A1
(43) Pub. Date: Feb. 12, 2004

(54) On demand aircraft charter and air taxi booking and dispatch system

(76) Inventors: Adam W. Webster, Auburn, ME (US); Scott M. Russell, Orrs Island, ME (US)

Correspondence Address: Robert K. Tendler, 65 Atlantic Avenue, Boston, MA, 02110, US

(21) Appl. No.: 10/212,571

(22) Filed: Aug. 5, 2002

(51) Int. Cl. G06F 17/60

(52) U.S. Cl. 705/13; 705/417

(57) ABSTRACT

An internet-based robust universal air taxi and charter system utilizes a centralized database and server to match trips with available aircraft in which the end user is presented with information about various available aircraft. To avoid out-of-date or erroneous information, all information is automatically inputted by aircraft vendors who use the central server for routine daily data entry for their businesses, with all vendors being continuously connected to the central server without the necessity of logging on to upload any additional data. Thus, the central server is used in the day-to-day business of the aircraft vendors. This provides automatically updated vendor files on a real-time basis to increase reliability and accuracy. In one embodiment chartering is accomplished by embedding specialized software tools at every travel agency, vendor and/or broker who subscribes. Also embedded are specialized software modules to give the local site a private label look and feel of the travel agency, broker or vendor by providing a user-defined “skin” for the brokering and chartering information.

### FIELD OF INVENTION

This invention relates to aircraft chartering and more particularly to a robust internet-based air taxi system.

### BACKGROUND OF THE INVENTION

Typically when an individual wishes to engage a charter service, the individual will call, for instance, the general aviation terminal at the particular airport that he is closest to or perhaps their travel agent. Someone at the general aviation terminal will usually suggest a given charter operator and the individual is given the telephone number of the charter operator. The charter operator may indicate to the individual that the requested itinerary cannot be met because the aircraft involved is in repair. He may then suggest another operator or attempt to broker the flight himself, all leaving the customer in a large quandary as to whether or not he can get from one city to another, and also what the price and the availability of the aircraft is. He is not necessarily provided with any information relating to the aircraft itself, its accommodations and characteristics, which may be of interest to him, and as a result chartering has not been as widely utilized as it could be.

On the other hand, customers are quite used to calling a cab company and having a cab dispatched to their location for carrying them to another location. What is therefore required is a convenient chartering system to make chartering as easy as calling for a cab. Moreover, the pitfalls of prior chartering systems such as, out-of-date or erroneous information are to be avoided.

Moreover, at the present time, there are no commonly used communications between air taxi operations and their customers. Presently less than 50% of air taxi operators use email as a reliable means of communication. Less than 1% use instant messaging technology. As a result air taxi reservations systems, in a back office sense, are completely haphazard and are random in their use, integration and perceived value. The typical air charter company either has a complete custom-built software management system or a random collection of three to seven different applications fulfilling various functions for management. None are exclusively server side applications or are able to interface with one another effectively.

### SUMMARY OF THE INVENTION

A system is provided as a turnkey solution for providing air chartering which includes a web presence in the reservation and booking process and to provide a web-connected global enterprise system for all back office functions for the air charter vendors. Because all vendors use the enterprise system, all information is automatically updated when a vendor uses the enterprise system to update records such as aircraft availability, condition, and specifications, as well as crew and mechanic availability.

The system permits a large number of owners of aircraft to advertise the availability of their aircraft for charter flights so as to provide a virtual taxi service in which the vendors provide relevant information over the internet into a central server that functions as an airplane repository, which includes scheduling and maintenance fields as well as crew fields. The services from the central server are accessible over the internet by not only travel agents, but also by others who by virtue of providing a website having the look and feel of a more traditional travel agency can provide a customer with accurate information to enable the dispatch of aircraft to the designated location.

The customer and/or agent can be selected along with a broker who in turn can access a number of vendors again through a website having the look and feel appropriate to the particular industry. Upon selection of an agent, and in turn a broker, followed by a vendor, a booking is confirmed through the airplane repository website. While the system does not necessarily require the customer's booking path to follow AGENCY, BROKER, and then VENDOR, it is designed in to enable as much participation as possible for existing industry participants, while being mindful of future pricing considerations.

In order to fix a chartering contract, the airplane repository website is coupled to a Quoter which is in turn connected to an agent, a customer or a broker so as to provide information at the site and in a format which permits each of these individuals to have the latest updated information. Not only is the accuracy of the information assured through the use of a central server, each of the vendors by subscription utilizes the central server and its CPU, not only to update the particular information for the associated aircraft, but also as a computational agent for all of the vendor's business. Thus, any time a vendor wishes to change information relating to a particular aircraft for reasons other than charter availability, this information is automatically placed in the central server so as to assure the reliability of the information to the brokers, agents or customers of the system.

For instance, a vendor's internal scheduler being processed by the central server, not only serves the vendor's personal needs, but also is immediately available to the remainder of the community to provide updated information. Thus, while the internal scheduler is visible to the particular vendor, this information is utilized to increase the accuracy of the information provided to the end users.

That which is available on the server is provided through the Quoter so as to arrange all of the information in an easily accessible format that is presented in the so-called skin of the particular agent, broker or customer that the agent, broker or customer is used to seeing. The Quoter is based on great circle distances and functions to provide the user with a number of choices as well as rate plans or prices for each leg of the user's proposed trip. It will be appreciated that when an individual agent or broker builds his or her quote, the available airports are listed along with what fixed based operators are available for refueling as well as customer services such as car rentals, restaurants, recreational facilities and the like. The result is that within a matter of minutes a customer can arrange for a charter flight from one location to another without having to physically visit either the agent, or the broker, or the vendor. Moreover, the customer is provided with personalized information so that he or she can make an informed choice.

It is therefore the purpose of the subject invention to provide this type of convenience to a customer so as to provide the customer with an alternative to crowded airports and commercial aviation hassles. The ability to provide a travel agent not only with a user-friendly screen, but also with information that is both complete and accurate is an advantage to facilitating a taxicab-like dispatch operation and thereby increases the number of charter flights booked.

It will be appreciated that once a booking has been completed, notification is provided to all entities, the customer, agent, broker and vendor. Likewise when a vendor takes his airplane out of service for maintenance or otherwise, the aircraft is listed as unbookable and if a booking is attempted, the notification system will indicate the status of the aircraft. In one embodiment, if an airplane is out of commission, the booking engine simply goes to the next logical aircraft.

In terms of aircraft maintenance, in one embodiment of the subject invention, the system provides the number of air miles or service cycles for the aircraft and automatically alerts the vendor to schedule maintenance requirements based on actual usage of the aircraft which is maintained by the booking system. Thus the booking system keeps track of aircraft usage.

In a preferred embodiment, the booking engine itself generates a charter contract and transmits it to the agent and/or customer, with the system providing a standard booking contract which has been simplified for customer ease of use.

The subject system also provides the users with a standard skin which is branded for each of the agents so that when their client comes to use the system, it appears as though the site belongs to the travel agent. The other reason for providing a customized skin is to make the agents perceive the system to be their system, with the system using the individual agents or terminology on the web page. This provides an individualized look and feel for all of the agents and brokers so that the actual booking engine is transparent to the user.

The subject system thus provides a scaffold or uniformity for chartering operations not heretofore possible due to the individual contracts and chartering procedures used. Since the vendors themselves subscribe to the central server and use it for everyday business, the structure afforded by the central server imposes this uniformity.

Thus the tools that are developed for use of the central server actually form the fabric of the lives of the vendors such that it is more convenient for the vendor to utilize this pre-established format and derive the benefits therefrom than to use a customized format, not necessarily understood by the system or any other broker's or agent's software.

The system thus eliminates all of the communications overhead and wastage in communications when individual chartering companies or brokers seek in a disparate way to conduct business. The system results in a reporting system for reporting aircraft availability, maintenance, utilization, pricing and other things, and does so in a convenient, automatic fashion.

Note, even though there are systems that purport to be a unifying charter brokering service, they are actually manually updated every morning by an individual telephoning a vendor or charter operator as to the status of all of his planes and their availability or non-availability. This causes numerous errors and unreliability. The prior systems also require a log-in on the part of the agent and/or vendor, each time the vendor seeks to use the system, with the log-ins generally being ignored or not used.

The subject system, however, has an automatic login through the subscription service so that the vendor is constantly online with the server, thus eliminating the problem of log-ins.

Another part of the subject invention is that the vendor is provided with maintenance schedules, which is a tool provided by the system which enables the vendor to be able to track crew, aircraft, keep track of required maintenance. While in the past software has been available to alert operators to required maintenance checks, these programs do not reside on a central server to which each of the vendors is connected.

In one embodiment the quoting system is fed directly by the vendor's maintenance system. For instance, if a mechanic decides to ground an aircraft for a bad oil leak, this information is typed directly into his terminal, which is away from the reservations terminal, for instance. This remotely typed-in information precludes the aircraft from being booked through the booking system in a matter of seconds.

In summary, an internet-based robust, accurate universal air taxi and charter system utilizes a centralized database and a server to match trips with available aircraft in which the end user is presented with information about various available aircraft. All information is automatically inputted by subscribers who use the central server for routine daily data entry for their businesses with all vendors being continuously connected to the central server without the necessity of logging on. Thus the central server runs the business of the aircraft vendors by having the aircraft vendors enter all their business data into the server. This provides completely updated vendor files on a realtime basis to increase reliability and accuracy.

In one embodiment the aircraft chartering is accomplished by embedding specialized software tools at every travel agency and/or broker who subscribes. Also embedded are specialized software modules to give the local site the look and feel of the travel agency, broker or vendor by providing a user-defined “skin” for the brokering and chartering information. Specialized tools include a Travel Agency/Broker Quoter, an Aircraft Vendor Quoter, an Aircraft Vendor Scheduler; a Vendor Enterprise module to assist in running the Aircraft Vendor's business, a GDS Integration/Interface, FBO Point of Sale devices or Wireless PDAs and software to assist in the collection of a transaction fee for each trip.

Rather than building one excessively large application, the subject system builds mini private label sites and uses information from the mini sites to develop the core application. Since data is generated during the day by a system integral to the user, there are no data interface issues as the data is already entered during the normal course of business of the vendor. Thus all data in the central server is based on a data pulled as new interfaces are built from a community of many participants, with the subject system with the subject system being a large and highly dynamic relational database that appears through localized and somewhat customized websites belonging to the respective members or customers of the relational database community, i.e., the subject system. In one embodiment, charter booking is automatically done via the Internet by the ultimate customer booking the charter. Note that the subject system is flexible so that route changes can be made in flight at times to optimize pricing for clients who have already started a trip.

### BRIEF DESCRIPTION OF THE DRAWINGS

These and other features of the subject invention will be better understood in connection will the Detailed Description in conjunction with the Drawings, of which:

FIG. 1 is a block diagram of the system illustrating the utilization of a Quoter by an agent, client, broker and vendor, with the vendor utilizing the centralized server for backroom house keeping and general business tasks;

FIG. 2 is a diagrammatic illustration of a screen shot viewable by a client, an agent, a broker, and or a vendor in which fields are provided to book a trip indicating the number of passengers and the trip type so as to receive a quote, also simultaneously presenting the types and qualifications of the aircraft to be chartered;

FIG. 3 is a diagrammatic illustration of a screen shot of the fields entered by a vendor, with the data stored at the central server and utilized in the quoting system of FIG. 1;

FIG. 4 is a flow chart diagram of the interface between the booking entity and the quoting system for the Quoter and the scheduling and management blocks of FIG. 1;

FIG. 5 is a diagrammatic representation of the scheduling of a flight utilizing the subject Quoter and scheduling components in which a time line is displayed indicating the particular aircraft and the particular crew and mechanic schedule, also indicating the crew available as well as the mechanic available, and indicating a black out period for the aircraft in which the aircraft is unavailable either due to mechanical issues or crew issues or due to a previously scheduled flight;

FIG. 6 is a block diagram illustrating a tailored weighted preference system in which a customer is guided through the agent selection, broker selection and vendor selection so as to provide the customer with a weighted selection as to the vendor and aircraft; and,

FIG. 7 is a diagrammatic illustration of a task load alerting system in which daily tasks are color coded as to the amount of activity for that particular day.

### DETAILED DESCRIPTION

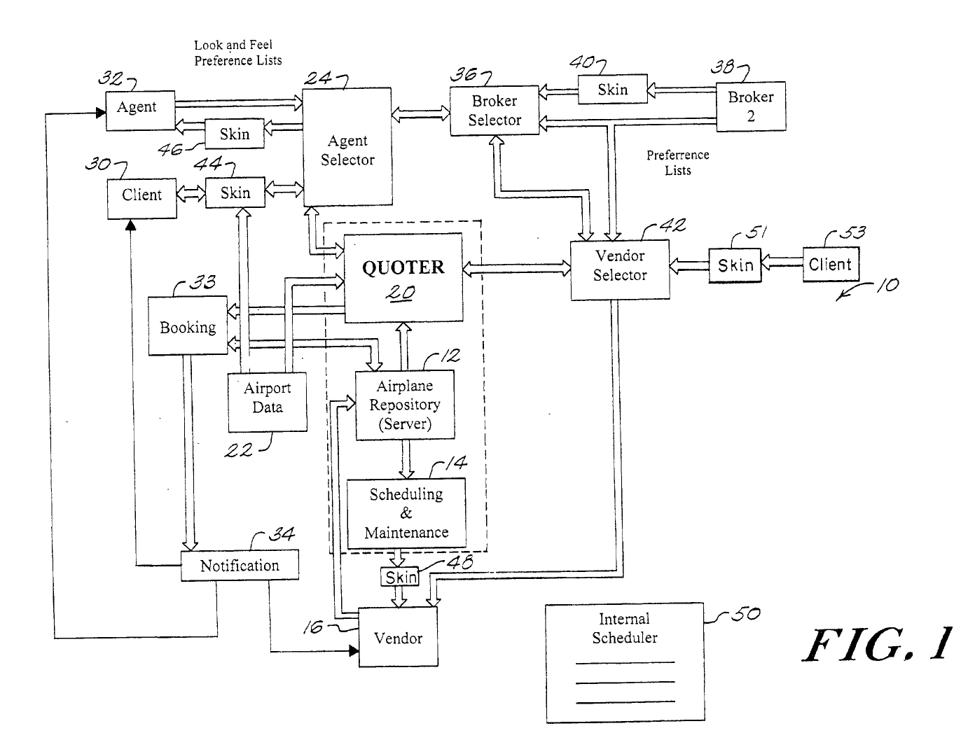

Referring to FIG. 1, a booking and scheduling system 10 includes a centralized server 12 which functions as the airplane repository into which is inputted scheduling and maintenance data as illustrated at 14 as well as vendor 16 information which includes, inter alia, all of the specifications of the aircraft, its availability from the vendor, the crew availability, and the availability of a mechanic, all of which are required in order to be able to quote a given trip:

The quotation is generated by a Quoter 20 which is fed with airport data 22 and is coupled to server 12.

The Quoter has outputs which are coupled via the Internet to the selected agent here illustrated at 24.

Quoter 20 after having been provided with the particular trip, along with the available aircraft and other information provides this information either to the ultimate client here illustrated at 30 or to the client's agent here illustrated at 32 through a notification system 34 so that either the agent or the client may be apprised of the particulars of the trip and can authorize the booking of the trip in terms of the fixing of a contract back through agent 24 and through Quoter 20. Upon the fixing of the contract or the booking, Quoter 20 provides a booking acknowledgement which is then passed through notification system 34 to either the agent or the client. Notification is also provided to the vendor 16 so that all parties to the transaction are provided with a detailed notification of the particular chartering contract.

As will be seen, it is possible in the subject system for the clients themselves to book a trip as long as the client is pre-qualified. The more-likely scenario is that the client will go to a particular agent such as travel agent who will through a particular “skin”, here illustrated at 40 provide the client with information regarding a projected trip, with the skin referring to the look and feel of the arrangement of data which is presented both in terms of fields of information and in terms of presentation materials which lie along side it. The particular skins may be tailored to the particular agent to have the look and feel that the agent normally utilizes, due to the commonality of the fields utilized in the subject chartering system. Fields include for instance the departure and destination airports, the number of passengers, the type of trip, be it one way, two way or a multi leg trip, along with other information in a multi-media sense including for instance a picture of the aircraft, its interior, or even pictures relevant to the trip such as advertising and spots of local interest.

All of this information is presented at the agent's terminal in the “skin” that the particular agent is currently using.

If the agent is the one contacted by the client, then the client is directed to the particular agent through agent selector 24, with the agent having a contractual relationship with the owner of the server in terms of a subscription.

Once having selected the agent, the agent can in one instance select a particular broker as illustrated at 36. The subject system in turn communicates with the selected broker 38 through the broker's skin here illustrated at 40.

The broker then must decide on a particular vendor, which is accomplished as illustrated at 42, with the vendor selected communicated to Quoter 20. The broker may select a single vendor or may select a group of vendors for purposes of quoting the particular trip.

Note that the information from the Quoter is provided in whatever format the client, agent, broker or vendor selects by selecting a “skin” for the presentation of the information from the Quoter. The skin for direct use by a client is as illustrated by skin 44, for the agent as illustrated by skin 46, and for the vendor as illustrated by skin 48.

While the subject system will be described in terms of involvement of the client, agent, broker and vendor, it will be appreciated that the agents and brokers can be bypassed assuming that the client is sufficiently sophisticated and has sufficient credit for booking the trip. In one embodiment, the client can go directly to a vendor such as vendor 42. Here he is provided with a display of information in the vendor's “skin” 51, such that a client 43 can deal directly with vendor 42 as if vendor 42 were an agent or broker.

Regardless of the number of entities involved in the booking transaction, notification system 34 notifies all the appropriate entities so that the same information resides at each entity.

It will be appreciated that all of the entities have the exact same information. This improves on the reliability of the booking system and identifies for each of the entities any error which may have occurred which can quickly be corrected.

It will also be appreciated that because the vendor utilizes server 12 for all of the vendor's business, all information provided by the vendor is updated in as real time as possible due to the fact that there is no lag between the vendor's specification of aircraft availability, crew availability and the like. This is because it is the central server which is in fact serving as the computation engine for the vendor in the vendor's daily business.

As such it will be seen that the vendor also has a screen 50, which is in one embodiment the internal scheduling display for the vendor.

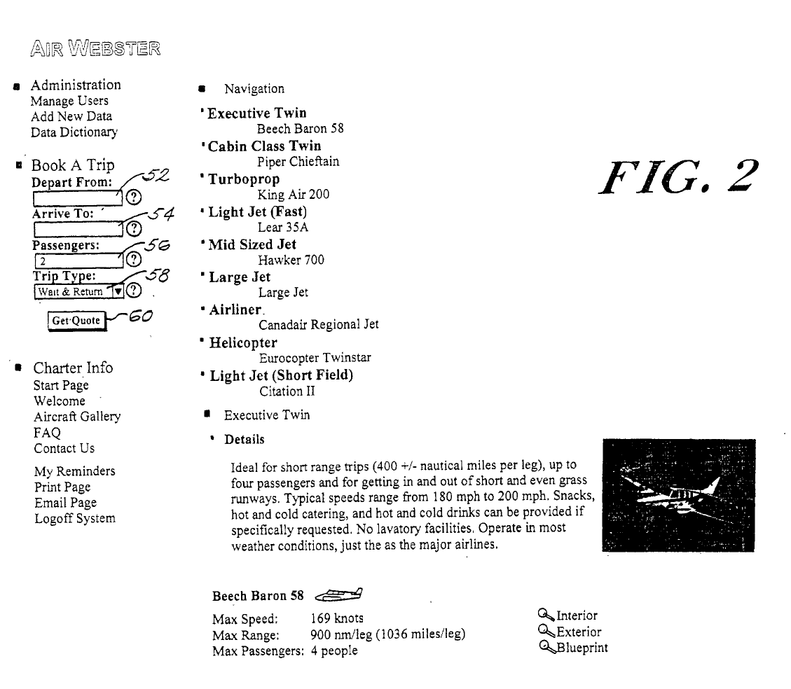

As part of the subject system, and referring now to FIG. 2, what is described is a screen shot of a particular skin for information which is presented either to the agent or by the agent to the client. The fields which are important are the departure location illustrated at field 52 and arrival location illustrated at field 54, the number of passengers illustrated at field 56 and the type of trip desired illustrated at 58.

The type of trip may either be a one-way trip, a two-way trip, a multi-leg trip or may also require that the aircraft wait for the passenger and then return. These types of fields are common to the skins of all of the entities mentioned above.

A trip request is initiated through the clicking on of the “get quote” button here illustrated at 60. As can be seen from the screen shot there is a multi-media display in which client, agent or broker can have an instant listing and view of the various types of aircraft available along with a description of the particular aircraft.

In the illustrated embodiment a Beach Barron 58 is illustrated as having a maximum speed of 169 knots, maximum range of 900 nautical miles and a maximum number of passengers of 4. The multi-media display also can display the interior, exterior or blueprint of the aircraft along with details, which is a narrative of the particular attributes of the particular aircraft. It will be appreciated that multi-media display is important in the selection process, both from the point of view of the client and from the point of view of either the agent or the broker. Information for this screen is provided by server 12 as updated by vendor 16.

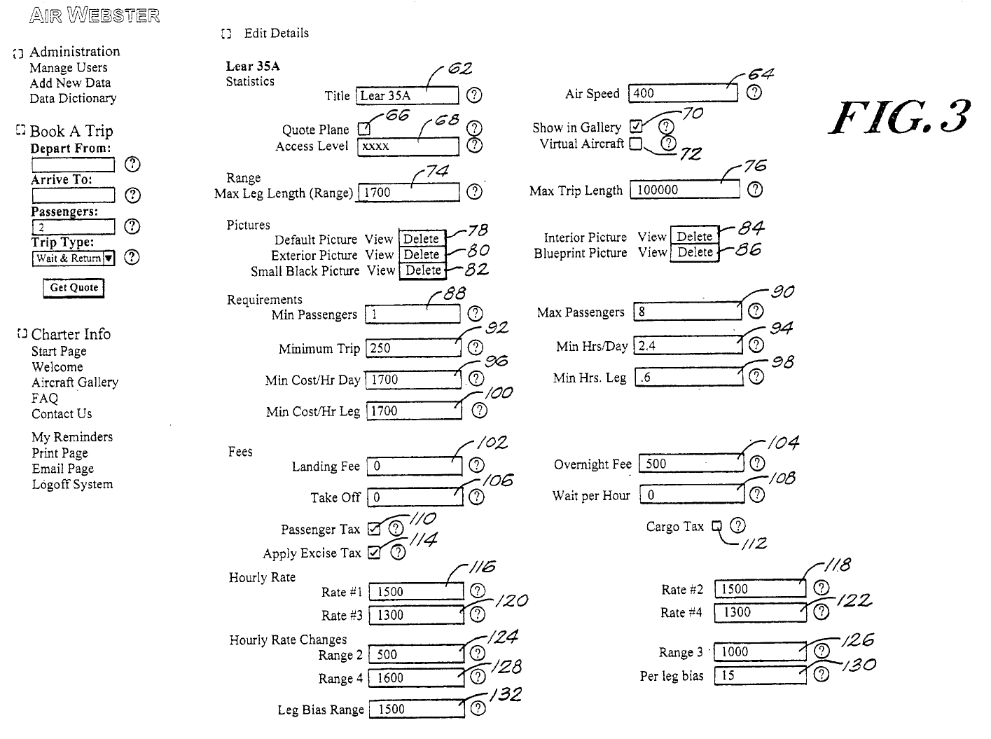

Referring to FIG. 3, what is shown is the data entry format for vendor aircraft, in which field 62 is provided for the name or model of the plane, field 64 for the airspeed, a field 66 for enabling a plane to be quoted, as opposed to being merely shown in the gallery, and a field 68 corresponding to access level meaning the permitted personnel to use the plane. In terms of access level, its use means to view or edit the data for this particular plane. A field 70 is used to authorize showing the plane and its data in the gallery, whereas a field 72 relates to a virtual aircraft, which is an aircraft used for quoting purposes but does not represent the natural physical aircraft. This permits brokers to quote aircraft that may or may not be available without first identifying that they are available.

Also included in the data entry format is a field 74 for indicating maximum range and a field 76 for indicating maximum trip length.

The data entry format is very versatile in that pictures may be supplied or deleted at the discretion of the particular vendor. For instance, field 78 which is the default picture of the aircraft, may be deleted, whereas in field 80 an exterior picture view, in field 82 a small block picture view, in field 84 an interior picture view, or as shown in field 86, a blue print picture view may be deleted assuming one was originally supplied.

As will be seen the data entry format also has a field 88 indicating the minimum number of passengers. There is a field 90 indicating the maximum number of passengers, a field 92 indicating the minimum acceptable trip and a field 94 illustrating the minimum hours per day to charge. As illustrated in 96 there is a minimum cost per hour per day, whereas field 98 indicates the minimum hours per leg to charge. Field 100 indicates the minimum cost per hour per leg.

In terms of fees, a landing fee field 102 is included. An overnight fee is included in field 104, a take off fee is included in field 106 and a field 108 is provided to indicate the amount to be charged per hour of waiting.

As can be seen by field 110, the field indicates whether or not the plane has a required passenger tax, and as seen in field 112 whether the plan has an associated cargo tax. As seen in field 114 some planes over a certain gross weight have the requirement that an excise tax be applied.

The hourly rates of the plane are entered in respective fields 114, 116, 118, 120 and 122 to indicate which are staged rates for different ranges, the rates being specified respectively in fields 124, 126 and 128. These fields specify the hourly rate ranges for 1-500 miles, 500-1000 miles and 1000-1600 miles, which rates apply to the hourly rates noted above. As seen in field 130 a per-leg bias is depicted in which for every leg of the flight additional minutes are added. These biases relate to the difficulty of turning the plane and getting it ready for take-off. The leg bias rate is entered in field 132.

It will be appreciated that the data entered by the vendor is used directly by the Quoter in providing the quotation for the trip. Since these fields are entered by the vendor, they can be provided in real time to the Quoter by virtue of their reposing in the airplane server due to the fact of the continuous connection of the vendor to the server.

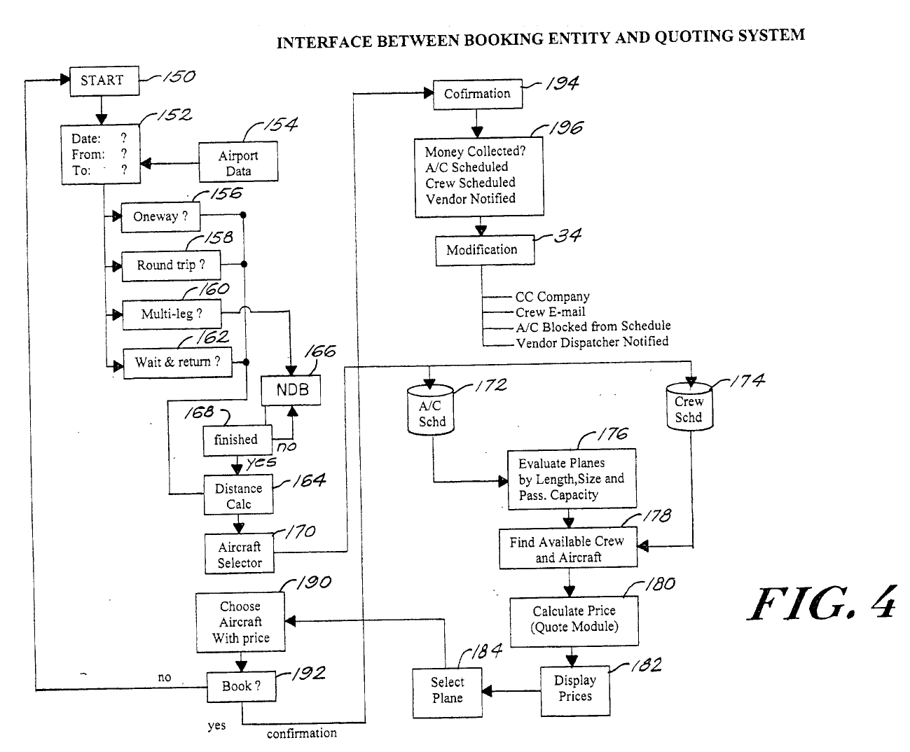

Referring now to FIG. 4, what is described is the interface between the booking entity and the quoting system of FIG. 1. As can be seen, in order to initiate a quote as shown at 150, the process is started in which the date and the “from” and “to” fields of block 152 are filled in. Airport data from storage 154 is inputted so that upon determining whether the trip is a one-way trip as illustrated at 156, a round trip as illustrated at 158, a multi-leg as illustrated at 160, or a wait-return as illustrated at 162 this fact is inputted to a distance calculating unit 164 or in the case of a multi-leg unit, a next decision block 166, the purpose of which will allow additional destinations to be inputted. A decision block 168 is provided to indicate whether or not the multi-leg trip has been finished. If all of the legs have been considered, then a total distance calculation is derived at 164.

After the distance calculation has been made, which in one embodiment is a great circle calculation; an aircraft is selected at 170 from the available aircraft stored at 172 and the crew data as stored at 174. The selected airplanes are limited as illustrated in 176 by trip length and by size as well as maximum passengers. The output of this unit is used along with an indication of available crew to find an available crew and aircraft as illustrated in 178, with the acceptable aircraft and crew then designating an available aircraft for which there is a calculated price as illustrated in 180. The prices are displayed as illustrated in 182, from which a plane may be selected at 184.

As illustrated in 190, there is an opportunity for the client, agent or broker to indicate that an aircraft with the appropriate crew at the appropriate price is acceptable. This indication is made to a booking unit 192, which upon approval goes to a confirmation block 194. If it is not acceptable, then the process is started again as illustrated in Block 150.

Confirmation includes field 196 that includes whether or not money has been collected, an aircraft has been selected, a crew has been scheduled, and that the vendor has been notified. Verification is accomplished by notification system 34 of FIG. 1 which includes notification that credit card has been confirmed, that the crew is available and notified by e-mail they have to work, that the aircraft is blocked from the schedule so that it cannot be booked by another entity and that the vendor has in fact been notified.

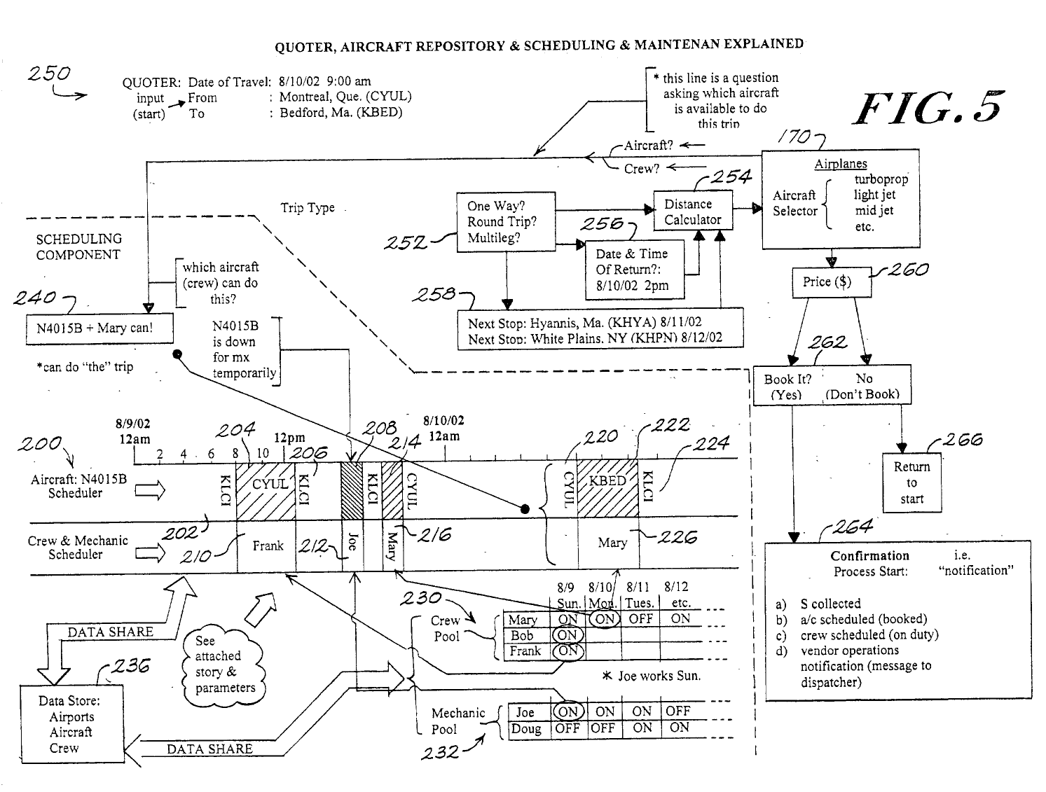

Referring now to FIG. 5, what will be seen is that within the Quoter, a timeline is generated and displayed such as illustrated at 200. Here, the identity of the scheduled aircraft is visually displayed along with symbols indicating that as to this particular airplane, it starts at Laconia which is KLCI, transits to Montreal, which is CYUL and returns to Laconia. This is illustrated by blocks 202, 204 and 206, all of which are presented on the timeline. As illustrated by block 208, the aircraft is indicated as being unavailable due to maintenance for the corresponding block of time.

The associated crew and mechanic are illustrated at field 210, such that Frank is indicated as the pilot for the particular flight. And as illustrated at 212, Joe is the mechanic. Then as illustrated at 214, the aircraft leaves Laconia and goes to Montreal where it is parked. The pilot for this flight is indicated at 216 to be Bob. It turns out that for the next flight from Montreal as illustrated at block 220, a flight to Bedford as illustrated at 222, namely KBED, finishes in Laconia as illustrated at 224, with Mary being the pilot as illustrated at 226. It is important to note that for this company Mary is available in Montreal on Monday.

It will be seen that the data on the crew pull is illustrated at 230 such that Mary, Bob and Frank are illustrated as being pilots, with their availability for each of the dates being denoted by whether the person is indicated as being “on” or being “off”.

Likewise as illustrated at 232, for the mechanic's pull, mechanics include Joe and Doug, with Joe and Doug being on or off as illustrated by the “on” or “off” indication in the corresponding fields.

It will be noted that with respect to the fields indicated by reference character 200, Mary is scheduled to fly into Montreal. However, it is federally mandated that pilots must have a predetermined period of rest before they can fly again. In order to assure compliance, the system depicts a guard zone, such that Mary after a certain period of time, as illustrated in 226, is permitted to fly. As can be seen from display 200, this means Mary is permitted to fly the plane from Montreal to Bedford, with the flight then finishing in Laconia. Note that the restriction is that the lay time must be 10 hours for every 24-hour period.

As also can be seen from display 200, there is a guard period in terms of piloting of this particular aircraft. The aircraft itself, however, can be piloted by someone else even if one pilot is precluded from flying.

So that, at a glance, the vendor, the broker, the agent or even the client can ascertain that the airplane is available, regardless of the amount of time that the particular pilot has left.

Note that in order to generate a presentation at display 200, data must be stored as illustrated at 236, which data comes from airport data 22, aircraft data 112 and crew data 174.

It will be appreciated that the data stored at 236 is data which is uniquely useable by the vendors whether or not it is used in booking or other venues. Thus upon entry of vendor data into the central server, this data provides for each vendor its own bookkeeping and scheduling system. After processing by the central server, this processed data is transmitted back to the vendor via the central server to which it is continuously connected. Thus the central server is used in generating information uniquely useable by each of the vendors.

Having discussed the scheduling component and the utilization of the display 200 to facilitate scheduling, it will be appreciated that the aforementioned Quoter takes information from the scheduling component to indicate that a given plane, namely plane N401SB with pilot Mary can in fact depart from Montreal and go to Bedford. This indication can be seen at 240 due to the query that is run.

Note that the Quoter as illustrated at 250 can schedule a trip from Montreal to Bedford on Aug. 10, 2002, with the particular aircraft selected by aircraft selector 170 of FIG. 4. The Quoter is provided with the one-way, round trip or multi-leg information as illustrated at 252 so that by virtue of which kind of trip is desired, distance calculator 254 calculates the distance. Here it can be seen that the one-way trip distance is rather easy to calculate. The round trip distance is derived from the round trip scheduling component 256, whereas the multi-leg component is calculated at 258.

Upon calculation of the appropriate distance, a price 260 is set and presented, whereas as illustrated at 262, it is either accepted or not. If accepted a confirmation process is started as illustrated at 264. As noted hereinbefore, if the booking is not accepted, one returns to start as illustrated at 266.

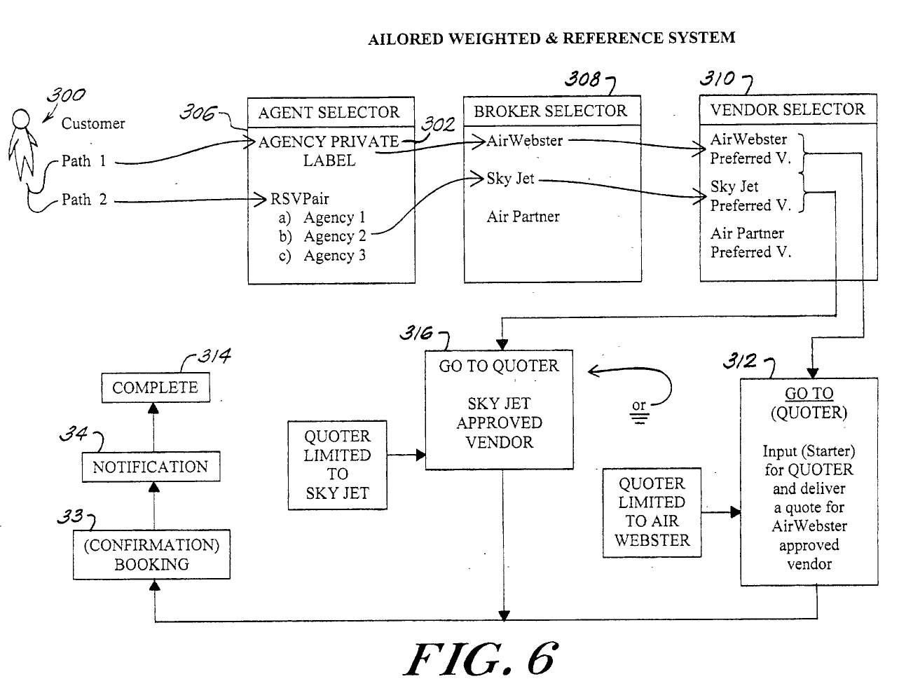

Referring now to FIG. 6, what is shown is a system for the tailored weighting for the selection of a vendor so as to be able to provide a method of selecting preferred vendors.

In this instance, a customer 300 goes either through path 1 or path 2, wherein path 1 works through an agency private label enterprise as illustrated in 302, or with a particular agent as illustrated in 304. The decision of which agent to use is illustrated at the agent selector box 306. Regardless of which agent is selected, a broker is selected at 308, with one of a number of agents being illustrated. The vendor selection is accomplished by vendor selector 310, which pre-selects preferred vendors depending on for instance, the particular broker's choices. Thus if the customer initially selected the private label agency, and the agency has a particularly good relationship with a particular broker, in this case Air Webster, then the system is weighted to select Air Webster's slate of vendors.

Having gone through vendor selector 310, the particular slate of Air Webster vendors is alerted as illustrated at 312 to initiate a quote for the entire trip. This quote is then inputted to the booking unit such as that illustrated at 33 in FIG. 1 or booking unit 194 in FIG. 4. Notification is then supplied to complete the process as illustrated at 314.

Note that if another broker is utilized, in this case Sky Jet, then Sky Jet has its own slate of vendors here illustrated at 316, which are then activated to provide the appropriate quote for booking and confirmation.

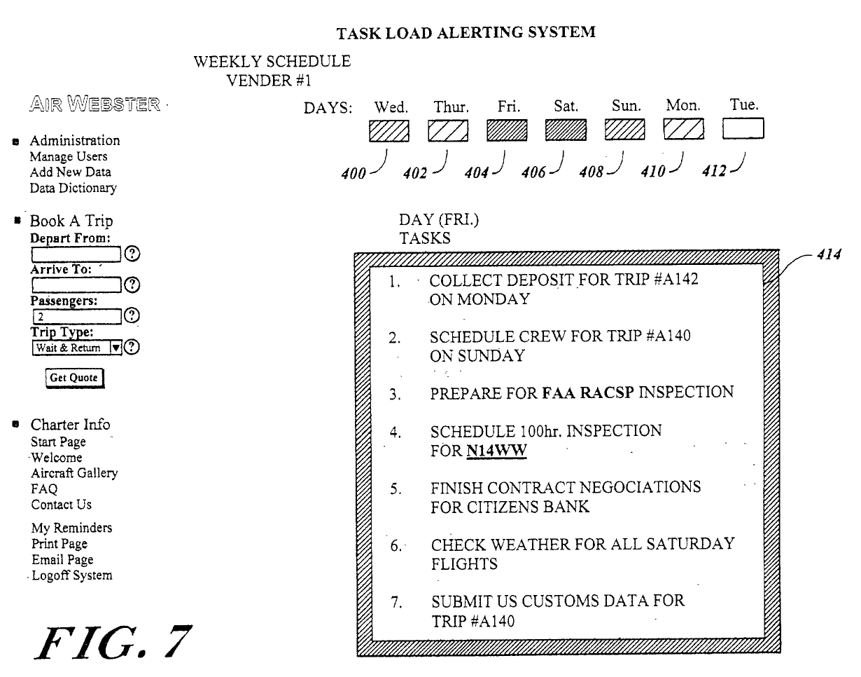

Referring now to FIG. 7, what is described as a sub-routine which provides a Task Load Alerting System. The purpose of the system is to alert at a glance what days have a large number of tasks to be performed, namely “heavy days”, those requiring no tasks, or those requiring only a few tasks. As can be seen, the tasks are shaded or color-coded, with shading or color codes indicating the amount of activity for each day of the week. Here as can be seen, color coded boxes 400, 401, 402, 404, 406, 408, 410 and 412 correspond to the task load, respectively for days Wednesday through Tuesday.

As can be seen for Wednesday, the workload is moderate as indicated by the moderate shading of the block 400, whereas for Thursday, the shading is light indicating a light task load. The shading for boxes 404, 406 and 408 is heavy, indicating that for Friday, Saturday and Sunday, a large number of tasks are to be performed each day, whereas for Monday the load is light and for Tuesday the load is non-existent.

Each of the tasks for each of the days is depicted below the task bar line. For instance for Friday, a number of tasks are as illustrated at box 414. These tasks are for instance collecting a deposit, scheduling a particular trip coming up on Sunday, preparing for an inspection, finishing contract negotiation with a particular bank, checking the weather for all of the Saturday flights, and submitting customs data for the designated trip on Monday.

The abovementioned Task Load Alerting System provides for a convenient page at a glance appraisal of the week's workload, while at the same time serving as a reminder of the tasks for each day.

A program listing follows which describes the subject system:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. An internet-based robust air taxi chartering system, comprising:
A centralized database and server to match trips with available aircraft and customers, said centralized database and server having a CPU; and,
an aircraft vendor terminal connected to said server through the Internet, said terminal being used to enter aircraft availability and data into said centralized database, said terminal coupled to said CPU for performing tasks of said vendor requiring a computer, all data and computations for said vendor being performed by said CPU at said centralized database and server such that information processed by said CPU related to air taxi chartering automatically and immediately updates said centralized database with current information, whereby out-of-date erroneous air taxi chartering information is avoided.

2. A method for forcing air taxi chartering vendors to provide current information to permit robust chartering with up-to-date information, comprising the steps of:
providing a centralized database and server connected to the Internet and adapted to house air taxi chartering information including aircraft availability, crew status and maintenance information, the centralized database and server having a CPU;
providing air taxi chartering information from each vendor using the CPU at the centralized database and server for general business, the CPU extracting from the CPU that information of a vendor which relates to the air taxi chartering; and,
automatically updating the central database with the extracted information, whereby the information stored in the database is up-to-date due to the use of the CPU by the vendor for all information processing of the vendor.

3. An air taxi chartering method for use by multiple entities, each having a different look and feel of information presented at a terminal, comprising the steps of:
connecting the terminal to the Internet; and,
providing a server and a centralized database coupled to the Internet and adapted to provide aircraft chartering information in a skin customized to the look and feel of the information presented at the terminal, whereby the information presented at the terminal appears to be the customized system of the entity, the underlying chartering information being processed centrally for all of the multiple entities.

4. The method of claim 3, wherein the entity includes a travel agency.

5. The method of claim 3, wherein the entity includes a broker.

6. The method of claim 3, wherein the entity includes an air taxi chartering vendor.

7. The method of claim 3, wherein access to the centralized database is on a subscription basis.

8. A system for alerting an air taxi charter vendor as to the daily workload involved in the associated air taxi chartering business, comprising,
a centralized database for storing data related to the air taxi chartering business on a day-to-day basis;
a terminal at said vendor coupled to said centralized database;
means at said terminal for displaying daily tasks, with a number of days portrayed at said terminal; and,
areas on said terminal denoting days of the week, said areas being coded so as to reflect the vendor workload for each of said days.

9. The system of claim 8, wherein said areas are color-coded, the colors depending on the associated daily workload.

10. The system of claim 8, wherein said areas are shaded, the shading of said areas depending on the associated daily workload.

11. The system of claim 8, wherein said database and said terminal are connected to the Internet.

12. In an air taxi chartering system, apparatus for displaying to an air taxi chartering entity the availability of an aircraft for charter, comprising:
a central database for storing air chartering information on an event-based timeline, said information including an aircraft schedule of where the aircraft departs and where the aircraft stops, said database storing crew availability on the same timeline; and,
a display for displaying said timeline and the events thereon, whereby inspection of said timeline correlates aircraft availability with crew availability.

13. The apparatus of claim 12, wherein said timeline has time slots and wherein selected portions of said information are displayed in associated timeslots.

14. The apparatus of claim 13, wherein said timeline has two rows of time slots displayed one above the other, one of said rows containing time slots having aircraft availability information and another of said rows containing crew availability information, whereby aircraft and crew availability is juxtaposed for easy viewing.

15. The apparatus of claim 12, wherein said timeline includes aircraft maintenance information and wherein said display includes said maintenance information.

16. The apparatus of claim 15, wherein said maintenance information includes mechanic availability, whereby all information relating to the air charter availability is presented on said timeline at said display.

17. An air taxi chartering system, comprising:
a quoter including a database accessible by a number of entities for storing air taxi chartering information; and,
terminals associated with said entitles for displaying the air taxi chartering information in said database.

18. The air taxi chartering system of claim 17, wherein said database stores this price for a charter based on air miles from a first location to a second location.

19. The system of claim 18, wherein said air miles are great circle air miles.

20. The system of claim 18, wherein said price includes a price associated with a predetermined service.

21. The system of claim 20, wherein said predetermined type of service includes one of one-way, round-trip, multi-leg and wait-and-return service.

22. The system of claim 17, and further including means for confirming a charter.

23. The system of claim 22, wherein said means for confirming a charter includes means for presenting the price of said charter and means for accepting the presented price.

24. The system of claim 23 and further including means for indicating that an accepted price is collected.
